(19) United States
(12) Patent Application Publication
(10) Pub. No.: US 2025/0274903 A1
(43) Pub. Date: Aug. 28, 2025

(54) INFORMATION PROCESSING METHOD AND COMMUNICATION DEVICE, AND STORAGE MEDIUM

(71) Applicant: Beijing Xiaomi Mobile Software Co., Ltd., Beijing (CN)

(72) Inventor: Yang SHEN, Beijing (CN)

(73) Assignee: Beijing Xiaomi Mobile Software Co., Ltd., Beijing (CN)

(21) Appl. No.: 18/848,254

(22) PCT Filed: Mar. 23, 2022
(86) PCT No.: PCT/CN2022/082609

§ 371 Date: May 19, 2025

(51) Int. Cl. H04W 64/00; H04W 4/02

(52) U.S. Cl. CPC H04W 64/003; H04W 4/025

(57) ABSTRACT

An information processing method, performed by a first network element, and may include: receiving location information of user equipment (UE) that is sent by a second network element; and obtaining a first determination result by determining whether the location information represents a current location of the UE.

### CROSS REFERENCE TO RELATED APPLICATION

The present application is a U.S. National Stage of International Application No. PCT/CN2022/082609, filed on Mar. 23, 2022 the contents of all of which are incorporated herein by reference in their entireties for all purposes.

### BACKGROUND OF THE INVENTION

After being turned on, user equipment (UE) needs to register with a network. Under normal circumstances, registration update may further be periodically performed by the UE. One or more tracking area identifiers (TAI) will be broadcasted by a base station. In a process of performing initial accessing, the UE will send a registration request message to a network side. After receiving the registration request message from the UE, the base station will send the broadcasted TAI and the registration request message together to an access management function (AMF). If the base station knows a tracking area (TA) where the UE is currently located, the base station will also send the TAI of the TA where the UE is currently located to the AMF. After receiving the above TAI, the AMF may construct a registration area (RA) for the UE based on the received TAI.

### SUMMARY OF THE INVENTION

A first aspect of an example of the disclosure provides an information processing method, performed by a first network element, including:
receiving location information of user equipment (UE) that is sent by a second network element; and
obtaining a first determination result by determining whether the location information represents a current location of the UE.

A second aspect of an example of the disclosure provides an information processing method, performed by a second network element, including:
acquiring location information of UE; and
obtaining a second determination result by determining whether the location information of the UE represents a current location of the UE.

A third aspect of an example of the disclosure provides a communication device, including a processor, a transceiver, a memory, and an executable program stored on the memory and capable of being run by the processor, where the processor, when running the executable program, executes the information processing method provided by the first aspect or the second aspect above.

A fourth aspect of an example of the disclosure provides a computer storage medium, and an executable program is stored in the computer storage medium; and the executable program, after being executed by a processor, is capable of implementing the information processing method provided by the first aspect or the second aspect above.

It needs to be understood that the above general descriptions and the following detailed descriptions are merely schematic and explanatory, and cannot limit the examples of the disclosure.

### BRIEF DESCRIPTION OF DRAWINGS

Accompanying drawings here, which are incorporated in and constitute a part of this specification, illustrate examples consistent with the disclosure and together with the specification serve to explain the principles of the examples of the disclosure.

FIG. 1 is a schematic structural diagram of a wireless communication system shown according to an example.

FIG. 2 is a schematic flow diagram of an information processing method shown according to an example.

FIG. 3 is a schematic flow diagram of an information processing method shown according to an example.

FIG. 4 is a schematic flow diagram of an information processing method shown according to an example.

FIG. 5 is a schematic flow diagram of an information processing method shown according to an example.

FIG. 6 is a schematic flow diagram of an information processing method shown according to an example.

FIG. 7 is a schematic flow diagram of an information processing method shown according to an example.

FIG. 8 is a schematic flow diagram of an information processing method shown according to an example.

FIG. 9 is a schematic flow diagram of an information processing method shown according to an example.

FIG. 10 is a schematic flow diagram of an information processing method shown according to an example.

FIG. 11 is a schematic broadcast diagram of a TAI shown according to an example.

FIG. 12 is a schematic broadcast diagram of a TAI shown according to an example.

FIG. 13 is a schematic structural diagram of an information processing apparatus shown according to an example.

FIG. 14 is a schematic structural diagram of an information processing apparatus shown according to an example.

FIG. 15 is a schematic structural diagram of UE shown according to an example.

FIG. 16 is a schematic structural diagram of a communication device shown according to an example.

### DETAILED DESCRIPTION OF THE INVENTION

Examples will be illustrated in detail here, and instances of which are represented in the accompanying drawings. When the following descriptions refer to the accompanying drawings, the same number in the different accompanying drawings represents the same or similar elements unless otherwise indicated. The implementations described in the following examples do not represent all implementations consistent with examples of the disclosure. On the contrary, they are merely examples of an apparatus and a method consistent with some aspects of the examples of the disclosure.

Terms used in the examples of the disclosure are merely for the purpose of describing the particular examples, and are not intended to limit the examples of the disclosure. The singular forms “a” and “this” used in the disclosure are also intended to include the plural forms as well, unless the context clearly indicates otherwise. It is to be further understood that a term “and/or” used in this text refers to and contains any and all possible combinations of one or more associated listed items.

It needs to be understood that the terms “first”, “second”, “third” and the like may be employed in the examples of the disclosure to describe various information, but these pieces of information need not be limited to these terms. These terms are merely used to distinguish the same type of information from one another. For example, in a case of not departing from the scope of the examples of the disclosure, first information may also be called second information, and similarly, the second information may also be called the first information. Depending on the context, the word “if” as used here may be interpreted as “at the time of” or “when” or “in response to determining”.

The disclosure relates to the technical field of wireless communications, but is not limited to the technical field of wireless communications, in particular to an information processing method and a communication device, and a storage medium.

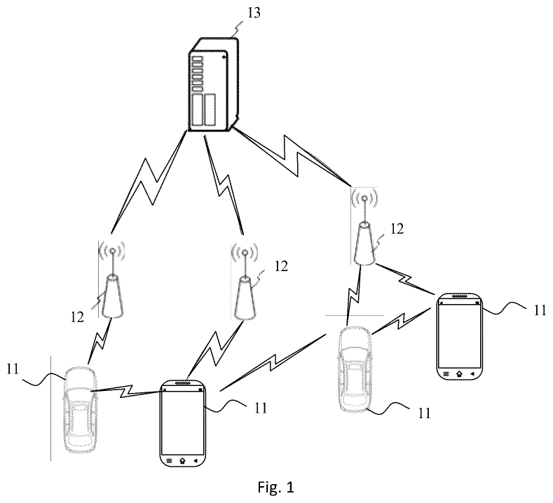

Please refer to FIG. 1, and FIG. 1 shows a schematic structural diagram of a wireless communication system provided by an example of the disclosure. As shown in FIG. 1, the wireless communication system is a communication system based on a cellular mobile communication technology, and the wireless communication system may include: a plurality of UE 11, a plurality of access devices 12 and a network server 13.

The UE 11 may refer to a device that provides voice and/or data connectivity to a user. The UE 11 may communicate with one or more core networks via a radio access network (RAN), and the UE 11 may be Internet of Thing UE, such as a sensor device, a mobile phone (or called a “cellular” phone) and a computer with the Internet of Thing UE. For example, the UE may be fixed, portable, pocket-sized, hand-held, computer-built or vehicle-mounted apparatuses. For example, the UE may be a Station (STA), a subscriber unit, a subscriber station, a mobile station, a mobile, a remote station, an access point, remote UE (a remote terminal), access UE (an access terminal), a user apparatus (a user terminal), a user agent, a user device, or user equipment (UE). Alternatively, the UE 11 may also be a device of an unmanned aerial vehicle. Alternatively, the UE 11 may also be a vehicle-mounted device, for example, a trip computer with a wireless communication function, or a wireless communication device externally connected to the trip computer. Alternatively, the UE 11 may also be a roadside device, for example, may be a streetlight with the wireless communication function, a signal light, or other roadside devices.

The access device 12 may be a network-side device in the wireless communication system. The wireless communication system may be the 4th generation mobile communication (4G) system, also known as a long term evolution (LTE) system; alternatively, the wireless communication system may also be a 5G system, also known as a new radio (NR) system or a 5G NR system. Alternatively, the wireless communication system may also be the next-generation system of the 5G system. An access network in the 5G system may be called a new generation-radio access network (NG-RAN). Alternatively, the access network may be called an MTC system.

The access device 12 may be an evolved access device (eNB) adopted in the 4G system. Alternatively, the access device 12 may also be an access device (gNB) that adopts a centralized distributed architecture in the 5G system. In response to determining that the access device 12 adopts the centralized distributed architecture, the access device usually includes a central unit (CU) and at least two distributed units (DU). The central unit is provided with protocol stacks of a packet data convergence protocol (PDCP) layer, a radio link control (RLC) protocol layer, and a media access control (MAC) layer; and the distributed unit is provided with a physical (PHY) layer protocol stack. The specific implementation of the access device 12 is not limited in the examples of the disclosure.

A wireless connection may be established between the access device 12 and the UE 11 through a wireless air interface. In different implementations, the wireless air interface is a wireless air interface based on the 4th generation mobile communication network technology (4G) standard; alternatively, the wireless air interface is a wireless air interface based on the 5th generation mobile communication network technology (5G) standard, for example, the wireless air interface is a new radio; alternatively, the wireless air interface may also be a wireless air interface based on a next generation of 5G mobile communication network technology standard.

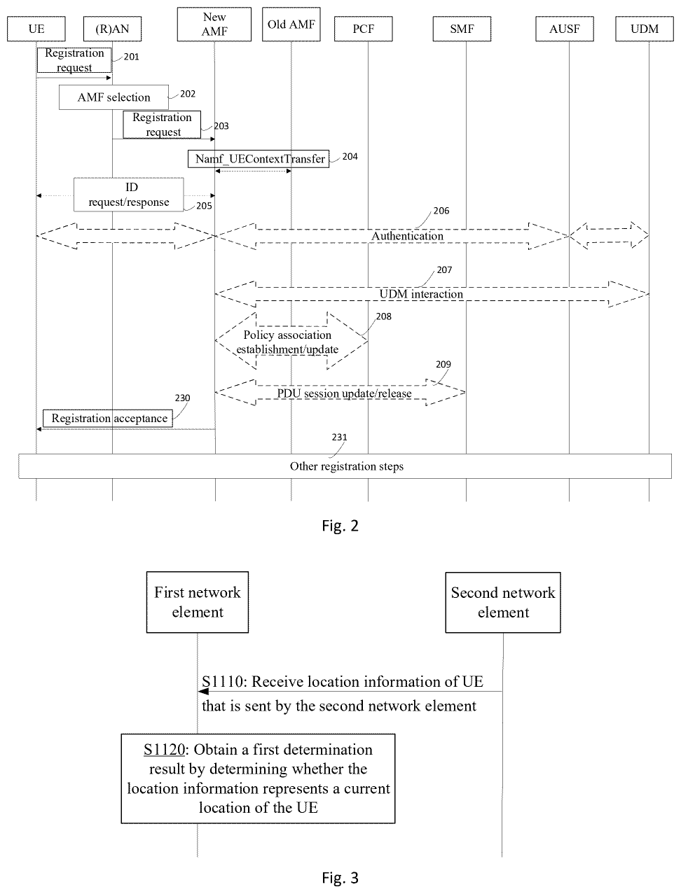

FIG. 2 shows a registration update process of UE, which may specifically include:

1) a registration request message is sent to a radio access network (RAN) by the UE at 201. The registration request message may include parameters such as a registration type, a Subscription concealed identifier (SUCI) or a 5th generation mobile communication (5G)-globally unique temporary identity (GUTI) or a permanent equipment identifier (PEI), requested network slice selection assistance information (NSSAI), and a tracking area identifier (TAI) last accessed.

The registration type of the UE includes first-time registration, mobile registration update, regular registration update, and emergency registration. The last accessed TAI may be included in the new registration request message to assist an access management function (AMF) in establishing a registration area (RA) for the UE.

2) AMF selection may include that the (R)AN selects the AMF according to a radio access technology or an access technology ((R)AT) and requests the NSSAI at 202. In response to determining that the (R)AN cannot select a suitable AMF, the registration request message will be forwarded to the AMF configured in the (R)AN.

3) A registration request is sent to the new AMF by the (R)AN, for example, the registration request is sent by sending an N2 message at 203. The message contains N2 parameters, the registration request, and the like. The N2 parameters include a selected public land mobile network (PLMN) identification (ID) ID, location information, and cell identification related to a cell where the UE resides.

4) Context transfer (Namf_UEContext Transfer) is performed at 204.

5) In response to determining that the AMF of the service has changed after the last registration, the stored subscriber permanent identifier (SUPI) and UE context of the UE may be retrieved by the new AMF from the old AMF at 205. In response to determining that the UE does not provide SUCI and does not acquire it from the old AMF, an identity request procedure is initiated by the new AMF to the UE to request the SUCI.

6) The new AMF may decide to initiate UE authentication by calling an authentication server function (AUSF) at 206. The AUSF is selected by the AMF according to the SUPI or the SUCI.

7) In response to determining that the AMF has changed since the last registration, or in response to determining that the UE provides the SUPI that does not reference a valid context in the AMF, then the AMF will select a UDM based on SUPI and register with a Unified Data Management (UDM) at 207. In response to determining that the AMF does not have subscription data of the UE, access, mobile subscription, and other data will be retrieved by the AMF from the UDM.

8) Establishment and modification associated with the AM Policy is executed by the new AMF for a PCF at 208.

9) In response to determining that a to-be-activated PDU session list is contained in the registration request in step 1, the AMF will send and acquire a session update request of the UE (Nsmf_PDUSession_UpdateSMContext request) to the SMF related to the PDU session, so as to activate user plane (UP) connections of these PDU sessions at 209.

10) A registration acceptance message is sent to the UE by the new AMF and indicates that the registration request has been accepted at 230. The registration acceptance message includes a registration area, mobility restriction, allowed NSSAI, strict timed registration timer indication, etc.

In response to determining that the AMF assigns a new registration area, the new registration area will be sent to the UE by the AMF. In response to determining that information of the registration area is not included in the registration acceptance message, the UE considers the old registration area to be valid.

In response to determining that the mobility restriction is applicable to the UE and the registration type is not emergency registration, then the mobility restriction is included.

11) The remaining steps of the registration process are performed at 231.

As shown in FIG. 3, an example of the disclosure provides an information processing method, performed by a first network element, including:
S1110, location information of UE that is sent by a second network element is received; and
S1120, a first determination result is obtained by determining whether the location information represents a current location of the UE.

The first network element may be various core network elements, for example, the first network element includes, but is not limited to an AMF.

According to the technical solutions provided by the examples of the disclosure, the first network element and the second network element will identify whether the location information of the UE is accurate enough, a spoofing behavior of the location information of the UE caused by various situations is reduced, and it is ensured that the location information is used correctly and reasonably later according to the determination result.

The location information may be carried in any message sent by the second network element (for example, the second network element may be an access network element) to the first network element. For example, the location information may be carried in an Next Generation Application Protocol (NGAP) message sent by the second network element to the first network element. The location information of the UE may include at least one of the following:
a TAI;
a cell identity; or
a base station ID.

Certainly, the above are merely examples of the specific content of the location information of the UE, and the specific implementation is not limited to the above examples.

The location information may be represented by different fields in the same message, which is equivalent to representing the location information through different fields, implicitly indicating whether the location information represents a current location or a proximity location of the UE. In this example, the message carrying the location information may include:
a second field, representing the current location of the UE; or a third field, representing the proximity location of the UE.

In the example of the disclosure, the second field and the third field are different fields. The difference between the second field and the third field may be reflected in any of the following aspects:
locations of the second field and the third field within the message are different; or,
the numbers of bits contained by the second field and the third field are different; or,
information formats of the second field and the third field are different.

In this example, obtaining the first determination result by determining whether the location information represents the current location of the UE is that after receiving the message, the first network element may directly determine whether the location information is the current location or the proximity location of the UE according to the different fields representing the location information of the UE.

In an example, the location information includes: a tracking area identifier (TAI), indicating a TA where the UE is currently located or a TA where the UE is proximately located.

The TA where the UE is proximately located may be a neighboring TA of the TA where the UE is currently located, but this is merely an example and the specific implementation is not limited to this example.

Certainly, the above are merely examples of determining whether the location information represents the current location of the UE, and the specific implementation is not limited to the above examples.

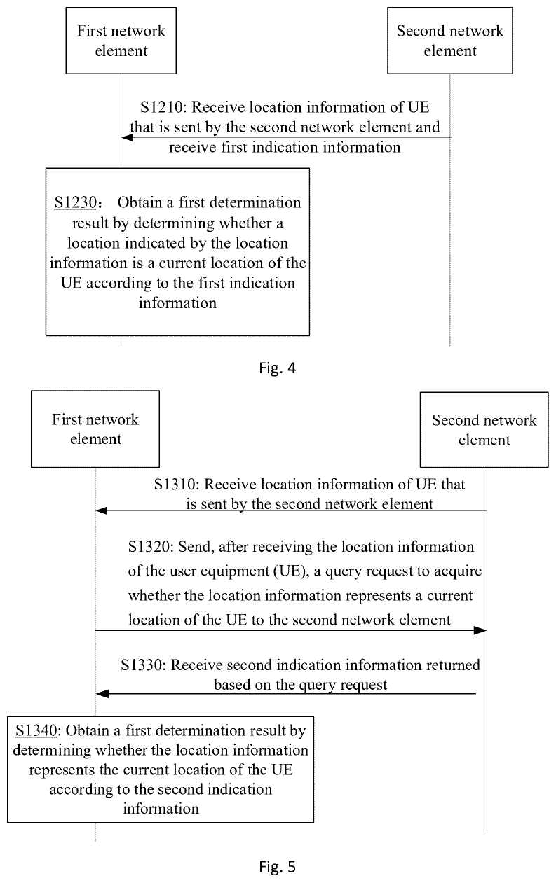

By introducing step S1120 above, whether the acquired location information of the UE represents the current location of the UE may be identified, which may assist in constructing a registration areas, a paging range and the like, and improving mobility management and paging efficiency. As shown in FIG. 4, an example of the disclosure provides an information processing method, performed by a first network element, including:

S1210, location information of UE that is sent by a second network element is received and first indication information is received, where the first indication information indicates that the location information represents a current location of the UE; or, the first indication information indicates that the location information represents a proximity location of the UE.

S1230, a first determination result is obtained by determining whether a location indicated by the location information is the current location of the UE according to the first indication information.

In the example of the disclosure, the first network element will receive the location information of the UE and further receive the first indication information. The first indication information may also be sent by the second network element. The first indication information and the location information may be carried in the same message and sent to the first network element, or may be sent respectively by the second network element to the first network element.

In summary, in the example of the disclosure, after receiving the location information, the first network element will determine whether the location information represents the current location of the UE according to the first indication information. In an example, the first indication information indicates that the location information represents the location where the UE is currently located, or represents the proximity location where the UE is located.

In some examples, the first indication information is:
a first field, configured to indicate that the location information represents the current location of the UE or the proximity location of the UE; where the first field and the field representing the location information may be different fields. or,
an indication bit in a field representing the location information, indicating that the location information represents the current location of the UE or the proximity location of the UE. The indication bit may be one or more bits.

The first field may include a field in any message sent by the second network element to the first network element, and the field may be a newly added field or a field dedicated to carrying the first indication information. For example, the first field may be a newly added field in an NGAP message.

As shown in FIG. 5, an example of the disclosure provides an information processing method, performed by a first network element, including:
S1310, location information of UE that is sent by a second network element is received;
S1320, after receiving the location information of the UE, a request to acquire whether the location information represents the current location of the UE is sent to the second network element;
S1330, second indication information returned based on the request is received; where the second indication information indicates that the location information represents the current location of the UE or a proximity location of the UE; and
S1340, the first determination result is obtained by determining whether the location information represents the current location of the UE according to the second indication information.

In the example of the disclosure, after receiving the location information of the UE, the first network element will send a request whether the location information represents the current location of the UE to the second network element. In this way, the first network element will receive the second indication information returned by the second network element based on the request, and the second indication information and the location information are apparently sent to the first network element by different messages.

In this example, the first network element may determine whether need to determine that the location information represents the current location of the UE as needed, so that there is no need to determine in advance whether the location information accurately indicates the current location of the UE, and the determination operation is merely performed as needed.

In some examples, the location information includes: a TAI, indicating a TA where the UE is currently located or a TA where the UE is proximately located.

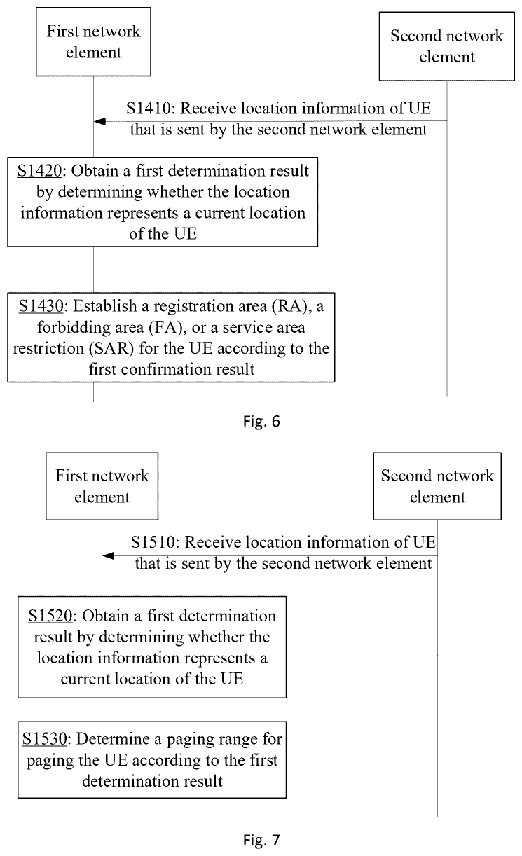

As shown in FIG. 6, an example of the disclosure provides an information processing method, performed by a first network element, including:
S1410, location information of UE that is sent by a second network element is received;
S1420, a first determination result is obtained by determining whether the location information represents a current location of the UE; and
S1430, a registration area (RA), a forbidding area (FA), or a service area restriction (SAR) for the UE is established according to the first determination result.

In the example of the disclosure, after the location information of the UE is received by the first network element, the first determination result may be obtained by determining whether the currently received location information represents the current location of the UE, and the RA, the FA, or the SAR is constructed for the UE according to the first determination result.

In an example, the first network element may establish the RA, the FA, or the SAR of the UE according to user subscription information, an operator strategy, and the first determination result, which may specifically include at least one of the following:
in response to determining that the first determination result indicates that the location information represents the current location of the UE, the RA, the FA, or the SAR is established for the UE according to the current location of the UE; for example, the RA includes the TA where the current location of the UE is located; for another example, in response to determining that the current location of the UE is a sensitive area, the SAR or the FA is constructed according to the sensitive area; or
in response to determining that the first determination result indicates that the location information represents the proximity location of the UE, the RA, the FA, or the SAR is established for the UE according to the proximity location of the UE and broadcast information; for example, the RA, the FA, or the SAR is constructed according to the TAI broadcasted by a base station.

Certainly, the above are merely examples of constructing the RA, the FA, or the SAR for the UE according to the first determination result, and the specific implementation is not limited to the above examples.

Because the first determination result is obtained by confirming the location information received by the first network element, constructing the RA, FA, and SAR based on the first determination result may improve mobility management of the UE.

As shown in FIG. 7, an example of the disclosure provides an information processing method, performed by a first network element, including:
S1510, location information of UE that is sent by a second network element is received;
S1520, a first determination result is obtained by determining whether the location information represents a current location of the UE; and
S1530, a paging range for paging the UE is determined according to the first determination result.

In an example, the first network element may determine the paging range of the UE according to an operator strategy and the first determination result, which may specifically include at least one of the following:
in response to determining that the first determination result indicates that the location information represents the current location of the UE, it is determined that the paging range of the UE includes a TA of a location indicated by the location information; or
in response to determining that the first determination result indicates that the location information represents a proximity location of the UE, it is determined that the paging range includes the TA of the location indicated by the location information and includes at least one adjacent TA of the TA of the location indicated by the location information.

Certainly, the above are merely examples of determining the paging range of the UE according to the first determination result, and the specific implementation is not limited to the above examples.

Because the first determination result is obtained by confirming the location information received by the first network element, in response to determining the paging range according to the first determination result, the UE may be paged faster, and a paging load is alleviated.

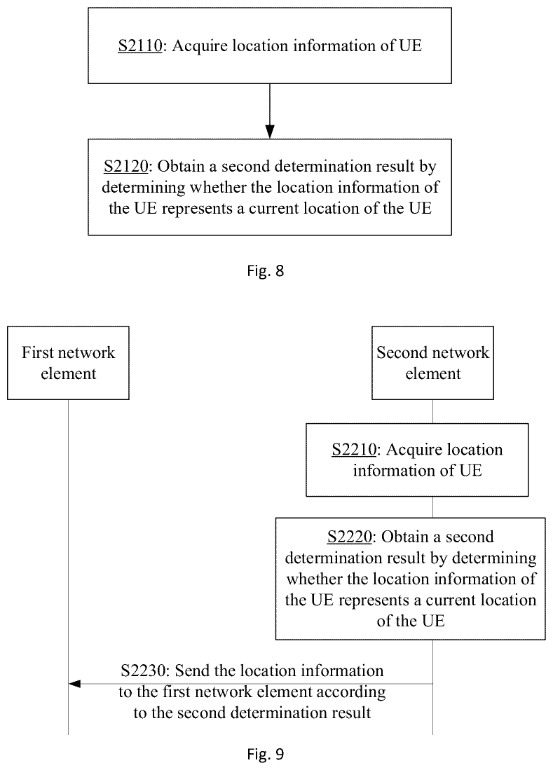

As shown in FIG. 8, an example of the disclosure provides an information processing method, performed by a second network element, including:
S2110, location information of UE is acquired; and
S2120, a second determination result is obtained by determining whether the location information of the UE represents a current location of the UE.

The second network element may be an access network element, and the access network element includes but is not limited to an evolved base station (eNB) or a next-generation base station (gNB).

The 2110 may include at least one of the following:
receiving the location information reported by the UE;
calculating the acquired location information of the UE through measurement; or
determining the location information of the UE according to the location information of other electronic devices bound to it.

Certainly, there are many ways for the second network element to determine the location information of the UE, and the specific implementation is not limited to any of the above.

The location information of the UE may include at least one of the following:
a TAI;
a cell identity; or
a base station ID.

Certainly, the above are merely examples of the specific content of the location information of the UE, and the specific implementation is not limited to the above examples.

The second determination result may include:
a determination result indicating that the location information represents the current location of the UE; or,
a determination result indicating that the location information represents a proximity location of the UE; or,
a determination result indicating that the location information does not represent the current location of the UE.

In some examples, S2120 may include determining whether the location information of the UE represents the current location or the proximity location of the UE according to measurement assistance data and measurement manners.

For example, the second network element comprehensively judges whether a measurement calculation result represents the current location or the proximity location of the UE based on measurement manners such as UE measurement, UE assisted measurement and network measurement, and the provided measurement assistance data.

Certainly, the above are merely examples of determining whether the location information represents the current location of the UE, and the specific implementation is not limited to the above examples.

Whether the location information of the UE is accurate enough may be identified through the introduction of step S2120 above.

As shown in FIG. 9, an example of the disclosure provides an information processing method, performed by a second network element, including:
S2210, location information of UE is acquired;
S2220, a second determination result is obtained by determining whether the location information of the UE represents a current location of the UE; and
S2230, the location information is sent to a first network element according to the second determination result.

In an example, the S2230 may include:
determining whether to send the location information to the first network element according to the second determination result; or,
determining an information content sent to the first network element according to the second determination result, where the information content may at least include the location information and may further include indication information of the second determination result.

For example, determining whether to send the location information to the first network element according to the second determination result may include:
sending the location information to the first network element in response to determining that the second determination result indicates that the location information represents the current location of the UE; and
not sending the location information to the first network element in response to determining that the second determination result indicates that the location information does not represent the current location of the UE.

For example, determining the information content sent to the first network element according to the second determination result may include at least one of the following:
sending the location information to the first network element in response to determining that the second determination result indicates that the location information represents the current location of the UE;
sending the location information and indication information indicating that the location information represents the proximity location of the UE to the first network element in response to determining that the second determination result indicates that the location information does not represent the current location of the UE; or
sending the location information, and the first indication information to the first network element, where the first indication information indicates the location information and contains the second determination result.

The above are all examples of S2230, and the specific implementation is not limited to the above examples.

In summary, sending the location information to the first network element according to the second determination result may allow the first network element receiving the location information to determine whether the location information represents the current location of the UE.

In some examples, S2230 may include:
sending the location information and/or first indication information containing the second determination result to the first network element according to the second determination result.

For example, the first indication information indicates that a location indicated by the location information is the current location of the UE;
or, the first indication information indicates that the location indicated by the location information is the proximity location of the UE.

In some examples, the first indication information includes:
a first field, configured to indicate that the location indicated by the location information is the current location of the UE or the proximity location of the UE; or,
an indication bit in a field representing the location information, indicating that the location indicated by the location information is the current location of the UE or the proximity location of the UE.

In an example, the first field may include a field in any message sent by the second network element to the first network element, and the field may be a newly added field or a field dedicated to carrying the first indication information. For example, the first field may be a newly added field in N2 messages such as a registration request message and/or a service request message. The first field carries the first indication information, and may be different from the field carrying the location information.

In response to determining that the location information and the first indication information are carried in the same field, different bits of the field indicate the location information and the first indication information respectively. For example, remaining bits indicating the location information in this field are used to carry the first indication information.

In an example, the first indication information may be carried by one or more indication bits, but these one or more indication bits themselves do not constitute a field. For example, the remaining bits of existing fields in NGAP messages such as the registration request message and/or the service request message are used to carry the first indication information.

The location information may be carried by different fields in the same message, which is equivalent to implicitly indicate whether the location information represents the current location or the proximity location of the UE through the different fields carrying the location information. Thus, a message containing the location information includes:
a second field, representing the current location of the UE; or a third field, representing the proximity location of the UE.

That is, in response to determining that the location information is carried in the second field, the location information indicates the current location of the UE; and in response to determining that the location information is carried in the third field, the location information indicates the proximity location of the UE.

The second field and the third field belong to different fields of the same message.

In the example of the disclosure, the second field and the third field are different fields. The difference between the second field and the third field may be reflected in any of the following aspects:
locations of the second field and the third field within the message are different; or,
the numbers of bits contained by the second field and the third field are different; or,
information formats of the second field and the third field are different.

In the example of the disclosure, according to the second determination result, the location information is carried by different fields of the message, and there is no need to specifically send the indication information of the second determination result, thus the characteristic of low signaling overhead is achieved.

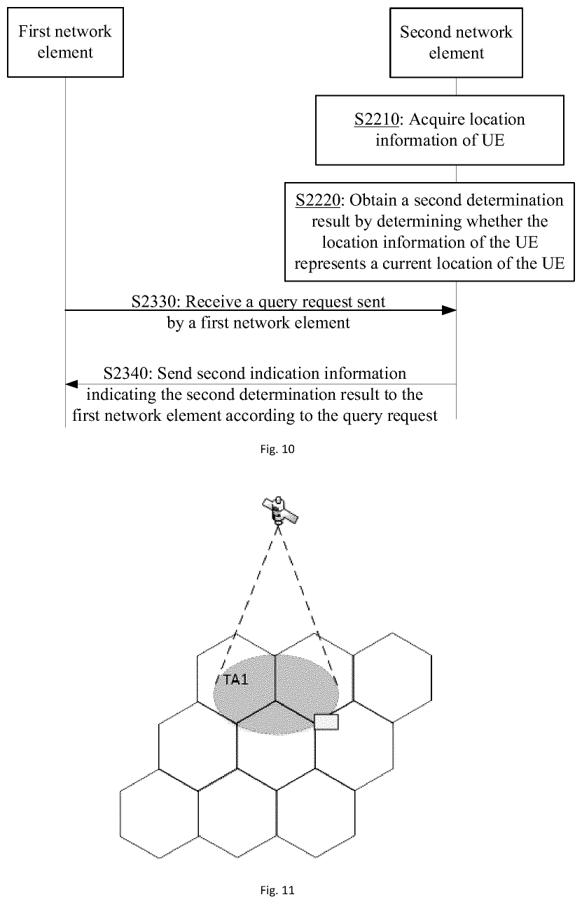

As shown in FIG. 10, an example of the disclosure provides an information processing method, performed by a second network element, including:
S2210, location information of UE is acquired;
S2220, a second determination result is obtained by determining whether the location information of the UE represents a current location of the UE;
S2330, a request sent by a first network element is received; and
S2340, second indication information indicating the second determination result is sent to the first network element according to the request.

In the example of the disclosure, after receiving the location information of the UE, the first network element will send a request whether the location information represents the current location of the UE to the second network element. In this way, the second network element will return the second indication information to the first network element based on the request, to inform the first network element whether the location information represents the current location of the UE.

In this example, the first network element may determine whether need to determine that the location information represents the current location of the UE as needed, so that there is no need to determine in advance whether the location information accurately indicates the current location of the UE, instead, it will merely send the second indication information indicating a second determination request to the first network element as needed, thus reducing information interaction between the first network element and the second network element.

In response to determining that the UE uses a satellite to access to a 5G core network, in a process of initial access to perform access registration, after receiving a registration request of the UE, an NG-RAN forwards the registration request to an AMF and meanwhile, needs to contain one or more TAIs broadcasted by a gNB in an NGAP message and send the NGAP message to the AMF.

In response to determining that the gNB knows the TAI corresponding to the TA where the UE is currently located, the TAI representing the location where the UE is located also needs to be contained in the NGAP message and is sent to the AMF.

According to a broadcast TAI list provided by the next generation radio access network (NG-RAN), the AMF constructs a suitable RA for the UE corresponding to the TAI of the current location of the UE. The RA may be a TAI list composed of a set of TAIs.

In an initial access process of the above UE, it is optional for the NG-RAN to provide the TAI representing the current location of the UE for the AMF. That is, the NG-RAN may not be able to acquire the TAI corresponding to the current location of the UE. In a case that the TAI representing the location of the UE cannot be provided for the AMF, the NG-RAN may provide a TAI for representing the proximity location of the UE. In this case, accuracy of the TAI identifying the location of the UE will be greatly reduced.

Thus, in an initial access phase of the UE, the NG-RAN may provide the TAI representing the location of the UE to the AMF, or may also provide the TAI representing the proximity location of the UE to the AMF. The AMF needs to construct a suitable RA according to the TAI provided by the NG-RAN, and in a subsequent process of paging the UE, in order to reduce the paging load, the use of the TAI in the RA (TAI list) needs to be minimized in the paging process. Thus, whether the NG-RAN provides the TAI representing the location of the UE is very important for the core network (such as the AMF).

In the initial access phase of the UE, in response to determining that the NG-RAN can acquire the TAI corresponding to the TA where the UE is currently located, the TAI is provided to the AMF. Otherwise, the NG-RAN will provide the TAI that identifies the proximity location of the UE to the AMF. A network device cannot judge whether the TAI can identify the TA where the UE is currently located according to the TAI, thus cannot guarantee whether the constructed RA is based on the current location of the UE, and cannot optimize the subsequent paging load.

When initiating a paging request on a network side, in order to reduce the paging load, the AMF needs to select a TA or a nearby TA that covers the location of the UE as much as possible from the RA according to the location of the UE as a paging range. According to the prior art, the NG-RAN may provide a TAI that identifies the location of the UE (i.e., the TAI of the TA where the UE is currently located) or a TAI that identifies the proximity location of the UE (e.g., a neighboring TAI of an area where the UE is located) to the core network. An example of the disclosure provides a method for perceiving a location of UE through a network. By learning whether a TAI provided by an NG-RAN can identify the location of the UE, accordingly, an appropriate RA and a paging range are constructed, a paging load is alleviated, and paging efficiency is improved.

A first network element acquires indication information of receiving the TAI and whether the TAI represents a TA where the UE is currently located, and an RA and/or a paging range are/is constructed according to the indication information and the received TAI.

A paging message is sent within the paging range; and the paging range may include one or more designated TAs.

The first network element is a core network element, such as an AMF.

Acquiring information indicating whether the TAI represents the TA where the UE is currently located by the first network element may include:

In an example, while the second network element sends the TAI to the first network element, indication information that the TA corresponding to the TAI is the TA where the UE is currently located, or second indication information that the TA corresponding to the TAI is not the TA where the UE is currently located is sent.

The second indication information may be used to indicate that the TA corresponding to the TAI represents the current location of the UE or represents the proximity location of the UE.

In another example, after receiving the TAI, the first network element queries the second network element whether the TAI corresponds to the current location of the UE, and the second network element returns a response whether the TAI corresponds to the current location of the UE. The second network element is an access network element, such as a gNB.

In an example, the indication information may display and indicate that the TA corresponding to the TAI is the TA where the UE is currently located, or is not the TA where the UE is currently located.

For example, undefined reserved bits identified by the TAI are borrowed, and the indication information is carried with one or more bits. That is, this bit may represent that the TAI identifies the TA where the UE is currently located, and 0 represents that the TAI identifies the TA of the proximity location of the UE.

In another example, whether the TA corresponding to the TAI is the TA where the UE is currently located, or is not the TA where the UE is currently located may be implicitly indicated.

For example, as shown in FIG. 11, the message sent by the gNB to the AMF contains a registration request message from the UE 1110. The registration request information may include: TAIs (TAI1, TAI2, TAI5) and TAI (TAI6), and the indication information. The indication information indicates that the TAI6 represents the current location of the UE, that is, the TA where the UE is currently located. TAIs (TAI1, TAI2, TAI5) are the TAI broadcasted by the base station. A satellite 1100 is shown in the figure.

After receiving the message and acquiring a registration request message from the UE, the AMF will obtain the TAIs (TAI1, TAI2, TAI5), TAI (TAI6), the indication information, etc., and based on the indication information, the TAI6 representing the current location of the UE is perceived, and an RA (TAI2, TAI6) is constructed according to the broadcast TAIs, TAI, and the indication information. The RA contains the TAI6.

Afterwards, once the AMF receives a request to trigger the sending of paging to the UE, the AMF sends a paging message according to the TAI6.

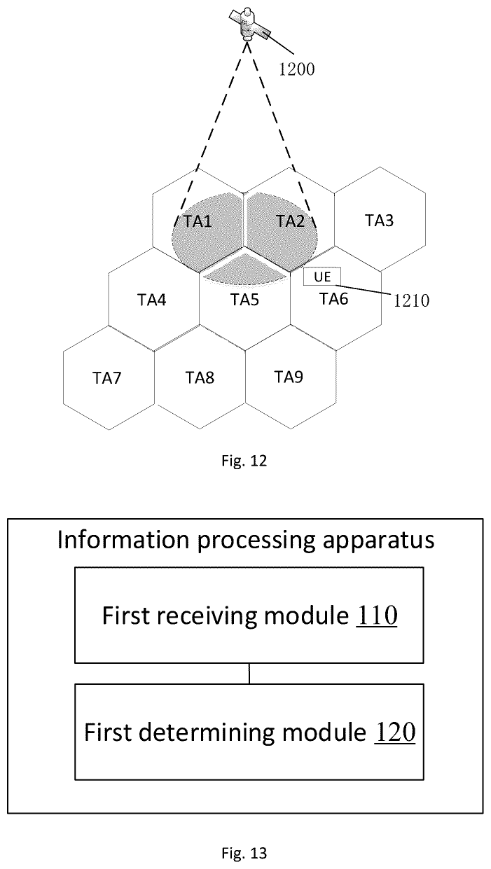

For another example, as shown in FIG. 12, for example, the message sent by the gNB to the AMF contains a registration request message from the UE 1210, TAIs (TAI1, TAI2, TAI5), TAI (TAI5), and indication information. In response to determining that the indication information indicates that the TAI represents the proximity location of the UE, that is, the TA where the UE is proximity located, TAIs (TAI1, TAI2, TAI5) are the TAI broadcasted by the base station. A satellite 1200 is shown in the figure.

After receiving the message, the AMF acquires the registration request message from the UE, and the registration request message may include: TAIs (TAI1, TAI2, TAI5), TAI (TAI5), and the indication information, etc. A situation that the TAI5 represents the proximity location of the UE is perceived according to the indication information, and RA (TAI1, TAI2, TAI5) is constructed according to the broadcast TAIs, TAI, and the indication information. The TAIs (TAI1, TAI2, TAI5) are the TAI broadcasted by the base station.

Afterwards, once the AMF receives a request to trigger the sending of paging to the UE, the AMF selects (TAI2, TAI5) as the range for sending the paging message according to the indication information, the RA, etc.

As shown in FIG. 13, an example of the disclosure provides an information processing apparatus, including:
a first receiving module 110, configured to receive location information of user equipment (UE) that is sent by a second network element; and
a first determining module 120, configured to obtain a first determination result by determining whether the location information represents a current location of the UE.

The information processing apparatus is contained in a first network element, and the first network element may include an AMF, etc.

In some examples, the apparatus may further include a storage module for storing the location information and the first determining module 120.

In some examples, the first receiving module 110 and the first determining module 120 may be program modules; and after being executed by a processor, the program modules can perform operations.

In some other examples, the first receiving module 110 and the first determining module 120 may be software and hardware combination modules, and the software and hardware combination modules include, but are not limited to: various programmable arrays. The programmable arrays include, but are not limited to: a field programmable array and/or a complex programmable array.

In further some other examples, the first receiving module 110 and the first determining module 120 may be pure hardware modules, and the pure hardware modules include, but are not limited to application-specific integrated circuits.

In some examples, the first determining module 120 is configured to receive first indication information, where the first indication information indicates that the location information represents the current location of the UE; or, the first indication information indicates that the location information represents a proximity location of the UE; the first determination result is obtained by determining whether the location indicated by the location information is the current location of the UE according to the first indication information.

In some examples, the first indication information includes:
a first field, indicating that the location information represents the current location of the UE or the proximity location of the UE; or,
an indication bit in a field representing the location information, indicating that the location information represents the current location of the UE or the proximity location of the UE.

In some examples, a message containing the location information includes:
a second field, representing the current location of the UE; or
a third field, representing a proximity location of the UE.

In some examples, the first determining module 120 is further configured to send, after receiving the location information of the user equipment (UE), a request to the second network element to acquire whether the location information represents the current location of the UE; receive second indication information returned based on the request; the second indication information indicating that the location information represents the current location of the UE or the proximity location of the UE; and obtain the first determination result by determining whether the location information represents the current location of the UE according to the second indication information.

In some examples, the location information includes: a tracking area identifier (TAI), indicating a TA where the UE is currently located or a TA where the UE is proximately located.

In some examples, the apparatus further includes:
an establishing module, configured to establish a registration area (RA), a forbidding area (FA), or a service area restriction (SAR) for the UE according to a first determination result.

In some examples, the apparatus further includes:
a paging range module, configured to determine a paging range for paging the UE according to the first determination result.

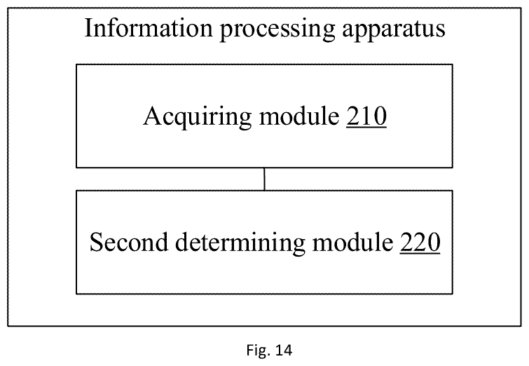

As shown in FIG. 14, an example of the disclosure provides an information processing apparatus, including:
an acquiring module 210, configured to acquire location information of UE; and
a second determining module 220, configured to obtain a second determination result by determining whether the location information of the UE represents a current location of the UE.

The information processing apparatus may be included in a second network element, and the second network element may include a base station, etc.

In some examples, the apparatus may further include a storage module for storing the location information and the second determining module 220.

In some examples, the acquiring module 210 and the second determining module 220 may be program modules; and after being executed by a processor, the program modules can perform operations.

In some other examples, the acquiring module 210 and the second determining module 220 may be software and hardware combination modules, and the software and hardware combination modules include, but are not limited to: various programmable arrays. The programmable arrays include, but are not limited to: a field programmable array and/or a complex programmable array.

In further some other examples, the acquiring module 210 and the second determining module 220 may be pure hardware modules, and the pure hardware modules include, but are not limited to application-specific integrated circuits.

In some examples, the apparatus further includes:
a first sending module, configured to send the location information to a first network element according to the second determination result.

In some examples, the first sending module is configured to send the location information and/or first indication information containing the second determination result to the first network element according to the second determination result.

In some examples, the first indication information indicates that a location indicated by the location information is the current location of the UE; or,
the first indication information indicates that the location indicated by the location information is a proximity location of the UE.

In some examples, the first indication information includes:
a first field, configured to indicate that the location represented by the location information is the current location of the UE or the proximity location of the UE; or,
an indication bit in a field representing the location information, indicating that the location represented by the location information is the current location of the UE or the proximity location of the UE.

In some examples, a message containing the location information includes:
a second field, carrying the current location of the UE; and/or,
a third field, carrying the proximity location of the UE.

In some examples, the apparatus further includes:
a second receiving module, configured to receive a request sent by a first network element; and
a second sending module, configured to send second indication information indicating the second determination result to the first network element according to the request.

An example of the disclosure provides a communication device, including:
a memory, configured to store executable instructions of a processor; and
the processor, respectively connected with the memory; where
the processor is configured to execute an information processing method provided by any of the aforementioned technical solutions.

The processor may include various types of storage media, which are non-transitory computer storage media that can continue to memorize information stored on it after the communication device is powered down.

Here, the communication device includes: UE or a network element, and the network element may be any one of the first network element to a fourth network element mentioned above.

The processor may be connected with the memory through a bus or the like, and configured to read an executable program stored on the memory, such as at least one of the methods shown in FIG. 2 to FIG. 10.

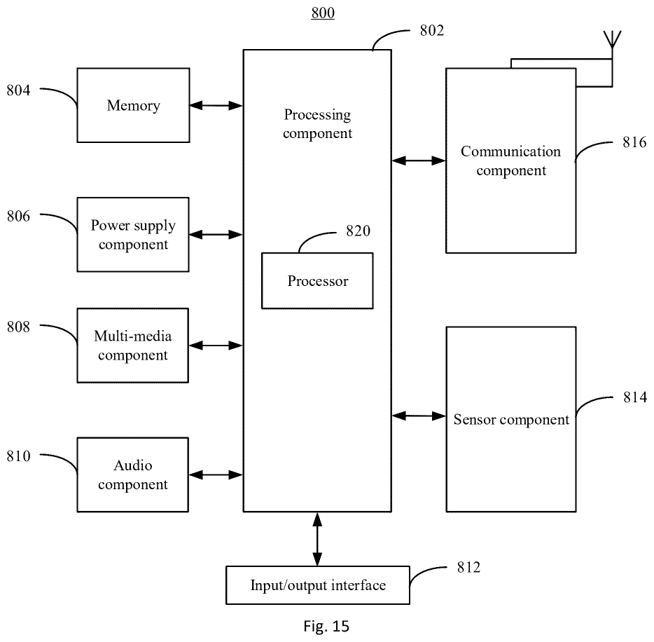

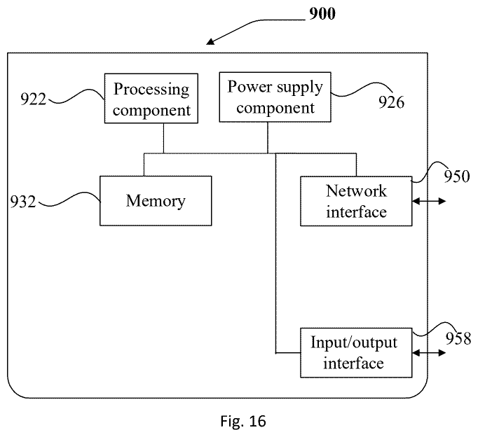

FIG. 15 is a block diagram of UE 800 shown according to an example. For example, the UE 800 may be a mobile telephone, a computer, digital broadcast user equipment, a message transceiving device, a game console, a tablet device, a medical device, a fitness device, a personal digital assistant, and the like.

Referring to FIG. 15, the UE 800 may include one or more of the following components: a processing component 802, a memory 804, a power supply component 806, a multimedia component 808, an audio component 810, an input/output (I/O) interface 812, a sensor component 814, and a communication component 816.

The processing component 802 usually controls an overall operation of the UE 800, such as operations associated with displaying, telephone calling, data communication, a camera operation and a record operation. The processing component 802 may include one or more processors 820 to execute an instruction, so as to generate all or part of steps of the above method. In addition, the processing component 802 may include one or more modules, so as to facilitate interaction between the processing component 802 and other components. For example, the processing component 802 may include a multimedia module, so as to facilitate interaction between the multimedia component 808 and the processing component 802.

The memory 804 is configured to store various types of data so as to support operations on the UE 800. Examples of these data include instructions of any application program or method used to be operated on the UE 800, contact data, telephone directory data, messages, pictures, videos, and the like. The memory 804 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 806 provides electric power for various components of the UE 800. The power supply component 806 may include a power management system, one or more power sources, and other components associated with generating, managing and distributing electric power for the UE 800.

The multimedia component 808 includes a screen providing an output interface between the UE 800 and a user. In some examples, the screen may include a liquid crystal display (LCD) and a touch panel (TP). In response to determining that the screen includes the touch panel, the screen may be implemented as a touch screen so as to receive an input signal from the user. The touch panel includes one or more touch sensors to sense touching, swiping and gestures on the touch panel. The touch sensor may not only sense a boundary of a touching or swiping action, but also detect duration and pressure related to the touching or swiping operation. In some examples, the multimedia component 808 includes a front camera and/or a back camera. In response to determining that the UE 800 is in an operation mode, such as a shooting mode or a video mode, the front camera and/or the back camera may receive external multimedia data. Each front camera and each back camera may be a fixed optical lens system or have a focal length and optical zooming capability.

The audio component 810 is configured to output and/or input an audio signal. For example, the audio component 810 includes a microphone (MIC). When the UE 800 is in the operation mode, such as a call mode, a recording mode or a speech recognition mode, the microphone is configured to receive an external audio signal. The received audio signal may be further stored in the memory 804 or sent via the communication component 816. In some examples, the audio component 810 further includes a speaker for outputting the audio signal.

The I/O interface 812 provides an interface between the processing component 802 and a peripheral interface module, and the above peripheral interface module may be a keyboard, a click wheel, buttons, etc. These buttons may include but are not limited to: a home button, a volume button, a start button and a lock button.

The sensor component 814 includes one or more sensors for providing state evaluations of all aspects for the UE 800. For example, the sensor component 814 may detect an on/off state of the device 800 and relative positioning of components, for example, the components are a display and a keypad of the UE 800. The sensor component 814 may further detect location change of the UE 800 or one component of the UE 800, presence or absence of contact between the user and the UE 800, azimuth or acceleration/deceleration of the UE 800, and temperature change of the UE 800. The sensor component 814 may include a proximity sensor, which is configured to detect existence of a nearby object without any physical contact. The sensor component 814 may further include an optical sensor, such as a CMOS or CCD image sensor, for use in an imaging application. In some examples, the sensor component 814 may further include an acceleration sensor, a gyroscope sensor, a magnetic sensor, a pressure sensor or a temperature sensor.

The communication component 816 is configured to facilitate wired or wireless communication between the UE 800 and other devices. The UE 800 may access a wireless network based on a communication standard, such as WiFi, 2G or 3G, or their combination. In an example, the communication component 816 receives a broadcast signal or broadcast related information from an external broadcast management system via a broadcast channel. In an example, the communication component 816 further includes a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the UE 800 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the above method.

In the example, a non-temporary computer readable storage medium including instructions is further provided, such as a memory 804 including instructions. The above instructions may be executed by a processor 820 of the UE 800 so as to generate the above method. For example, the non-temporary computer readable storage medium may be an ROM, a random access memory (RAM), a CD-ROM, a magnetic tape, a floppy disk, an optical data storage device and the like.

As shown in FIG. 16, an example of the disclosure shows a structure of an access device. For example, the communication device 900 may be provided as a network-side device. The communication device may be the aforementioned access network element and/or core network element.

Referring to FIG. 16, the communication device 900 includes a processing component 922, which further includes one or more processors, and a memory resource represented by a memory 932, for storing instructions executable by the processing component 922, such as an application program. The application program stored in the memory 932 may include one or more modules with each corresponding to a set of instructions. In addition, the processing component 922 is configured to execute the instructions so as to execute any of the aforementioned methods applied to the access device, for example, the methods shown by any one from FIG. 2 to FIG. 10.

The communication device 900 may further include a power supply component 926 configured to execute power supply management of the communication device 900, a wired or wireless network interface 950 configured to connect the communication device 900 to a network, and an input/output (I/O) interface 958. The communication device 900 may operate based on an operating system stored in a memory 932, such as Windows Server TM, Mac OS XTM, UnixTM, LinuxTM, FreeBSDTM or the like.

Those of skill in the art will easily figure out other implementation solutions of the disclosure after considering the specification and practicing the invention disclosed here. The disclosure intends to cover any transformation, usage or adaptive change of the disclosure, and these transformations, usages or adaptive changes conform to a general principle of the disclosure and include common general knowledge or conventional technical means which are not disclosed here in the technical field. The specification and the examples are merely regarded as an example, and the true scope and spirit of the disclosure are indicated by the following claims.

It will be appreciated that the disclosure is not limited to the exact structure that has been described above and shown in the accompanying drawings, and that various modifications and changes may be made without departing from its scope. The scope of the disclosure is merely limited by the appended claims.

1. An information processing method, performed by a first network element, comprising:
receiving location information of user equipment (UE) that is sent by a second network element; and
obtaining a first determination result by determining whether the location information represents a current location of the UE.

2. The method according to claim 1, wherein obtaining the first determination result by determining whether the location information represents the current location of the UE comprises:
receiving first indication information, wherein the first indication information indicates that the location information represents the current location of the UE; or, the first indication information indicates that the location information represents a proximity location of the UE;
obtaining the first determination result by determining whether the location indicated by the location information is the current location of the UE according to the first indication information.

3. The method according to claim 2, wherein the first indication information comprises:
a first field, indicating that the location information represents the current location of the UE or the proximity location of the UE; or,
an indication bit in a field representing the location information, indicating that the location information represents the current location of the UE or the proximity location of the UE.

4. The method according to claim 1, wherein a message containing the location information comprises:
a second field, representing the current location of the UE; or,
a third field, representing a proximity location of the UE.

5. The method according to claim 2, wherein obtaining the first determination result by determining whether the location indicated by the location information is the current location of the UE further comprises:
sending, after receiving the location information of the UE, a request to the second network element to acquire whether the location information represents the current location of the UE;
receiving second indication information returned based on the request; the second indication information indicating that the location information represents the current location of the UE or a proximity location of the UE; and
obtaining the first determination result by determining whether the location information represents the current location of the UE according to the second indication information.

6. The method according to claim 1, wherein
the location information comprises: a tracking area identifier (TAI), indicating a TA where the UE is currently located or a TA where the UE is proximately located.

7. The method according to claim 1, further comprising:
establishing a registration area (RA), a forbidding area (FA), or a service area restriction (SAR) for the UE according to the first determination result.

8. The method according to claim 1, further comprising:
determining a paging range for paging the UE according to the first determination result.

9. An information processing method, performed by a second network element, comprising:
acquiring location information of UE; and
obtaining a second determination result by determining whether the location information of the UE represents a current location of the UE.

10. The method according to claim 9, further comprising:
sending the location information to a first network element according to the second determination result.

11. The method according to claim 10, wherein sending the location information to the first network element according to the second determination result comprises:
sending the location information and/or first indication information containing the second determination result to the first network element according to the second determination result.

12. The method according to claim 11, wherein
the first indication information indicates that a location indicated by the location information is the current location of the UE; or,
the first indication information indicates that the location indicated by the location information is a proximity location of the UE.

13. The method according to claim 11, wherein the first indication information comprises:
a first field, configured to indicate that the location indicated by the location information is the current location of the UE or the proximity location of the UE; or,
an indication bit in a field representing the location information, indicating that the location indicated by the location information is the current location of the UE or the proximity location of the UE.

14. The method according to claim 9, wherein a message containing the location information comprises:
a second field, representing the current location of the UE; or
a third field, representing a proximity location of the UE.

15. The method according to claim 9, further comprising:
receiving a request sent by a first network element; and
sending second indication information containing the second determination result to the first network element according to the request.

16-17. (canceled)

18. A communication device, comprising a processor, a transceiver, a memory, and an executable program stored on the memory and capable of being run by the processor, wherein the processor is configured to:
receive location information of user equipment (UE) that is sent by a second network element; and
obtain a first determination result by determining whether the location information represents a current location of the UE.

19. A non-transitory computer storage medium, wherein the non-transitory computer storage medium stores an executable program, and the executable program implements when executed by a processor causes the processor to execute the information processing method according to claim 1.

20. The communication device according to claim 18, wherein the processor is configured to:
receive first indication information, wherein the first indication information indicates that the location information represents the current location of the UE; or, the first indication information indicates that the location information represents a proximity location of the UE;
obtain the first determination result by determining whether the location indicated by the location information is the current location of the UE according to the first indication information.

21. A communication device, comprising a processor, a transceiver, a memory, and an executable program stored on the memory and capable of being run by the processor, wherein the processor is configured to implement the information processing method according to claim 9.

22. A non-transitory computer storage medium, wherein the non-transitory computer storage medium stores an executable program, and the executable program implements when executed by a processor causes the processor to execute the information processing method according to claim 9.
